(19) United States
(12) Patent Application Publication
(10) Pub. No.: US 2023/0025567 A1
(43) Pub. Date: Jan. 26, 2023

(54) ELEVATOR SYSTEM WITH FRICTION DRIVE

(71) Applicant: Inventio AG, Hergiswil (CH)

(72) Inventor: Urs Baumgartner, Wolfwil (CH)

(21) Appl. No.: 17/757,840

(22) PCT Filed: Dec. 18, 2020
(86) PCT No.: PCT/EP2020/087225

§ 371 Date: Jun. 22, 2022

(30) Foreign Application Priority Data
Dec. 23, 2019 (EP) 19219355.5

(51) Int. Cl. B66B 9/00; B66B 9/02

(52) U.S. Cl. CPC B66B 9/003; B66B 9/02

(57) ABSTRACT

An elevator system includes at least one shaft and at least one car arranged in the shaft, wherein the shaft is divided into multiple shaft portions, and a plurality of friction drive units are mounted on at least one shaft wall of the shaft. The friction drive units each have at least two friction wheels and wherein the car is moved in each shaft portion by at least one of the friction drive units during operation of the elevator. In at least one of the shaft portions the friction drive unit is driven in an adjustable manner so that the car is moved at a substantially continuously adjustable speed at least in this shaft portion during operation.

### FIELD

The invention relates to an elevator system comprising a friction drive. The elevator system can comprise one or more cars. The invention is particularly suitable for an elevator system having multiple cars that can be moved in at least one shaft.

### BACKGROUND

U.S. Pat. No. 5,921,351 discloses an elevator system in which a car is moved along a predetermined path by a drive mechanism. This drive mechanism has a multiplicity of driven belts arranged one behind the other. The drive force is transmitted from the belt to the car via a frictional connection between a friction surface of a belt and an associated surface of the car.

WO 2009/074627 A1 discloses an elevator system having elevator cars that can be moved vertically and horizontally.

US20160152446A1 discloses an elevator system having belts and multiple cars that can be moved vertically and horizontally.

### SUMMARY

The problem addressed by the invention is that of providing an elevator system and a method that allow an improved mode of operation. The elevator system can in particular be used to transport people in one or more cars. In particular, the problem here can be that of being able to transport people in at least one car in an improved manner.

In the following, solutions and suggestions for a corresponding design are given which relate to the elevator system and solve at least parts of the stated problem. In addition, advantageous supplemental or alternative developments and embodiments are provided.

In one solution, an elevator system comprising at least one shaft and at least one car which is arranged in the shaft can be provided, wherein the shaft is divided into multiple shaft portions, wherein a plurality of friction drive units are provided, the friction drive units being mounted on at least one shaft wall of the shaft, the friction drive units each having at least two friction wheels, wherein the car can be moved in each shaft portion by at least one of the friction drive units during operation and wherein in at least one shaft portion the at least one friction drive unit can be driven in an adjustable manner so that the car can be moved at a substantially continuously adjustable speed at least in this shaft portion during operation.

In one embodiment, this is achieved in that the speed of each friction drive unit can be adjusted independently of the other friction drive units.

In a further solution, a method for driving cars of a proposed elevator system can be provided, wherein friction drive units are used to continuously adjust the speed of at least one car on the basis of at least one operating state of at least one other car.

In a further solution, a method for transporting people using a proposed elevator system can be provided, wherein at least two cars are moved in at least two shafts by means of friction drive units arranged on shaft walls, and wherein the cars are moved through the shafts at at least substantially continuously adjustable speeds during operation.

It is advantageous that at least one of the friction drive units has an endless belt, that the friction wheels of this friction drive unit are surrounded by the endless belt and that at least one of the friction wheels can be driven by a drive unit. As a result, an advantageous design of the friction drive units is possible.

Friction wheels are thus to be understood above and below as wheels for transmitting a traction force to the elevator car or to a belt. In other words, the traction force can be transmitted directly from the friction wheel to a part of the car, i.e. the car itself or to an additional part which is specially designed for force transmission and is attached to the car. For the purposes of this invention, however, a friction wheel also means wheels which do not transmit the traction force directly to the car, but to an endless belt, for example, with the belt transmitting the traction force by friction to the car or a part attached to the car for this purpose.

It is advantageous that the car has at least one traction plate to which a driving force for moving the car in the shaft is temporarily transmitted during operation by at least one of the friction drive units. As a result, an advantageous transmission of force to the car is possible. In a modified embodiment, another part of the car can also assume the function of a traction plate. A traction plate can then optionally be omitted.

It is advantageous that at least one of the friction drive units comprises additional wheels which are tensioned by a tensioning mechanism, in particular at least one spring, in such a way that they exert a pressing force directed toward a part of the car, in particular toward a traction plate of the car. Preferably, the part to which the pressing force is directed is thus the traction plate. Due to the possible designs according to this feature, an advantageous adaptation to the relevant application is possible. Furthermore, the drive of the car can be further optimized.

It is advantageous that at least one further shaft is provided, that at least one changeover point is realized between the shaft and the further shaft, that at least one carriage unit is provided which can be displaced at the changeover point between the shaft and the further shaft during operation, and that the car can be transferred at the changeover point between the shaft and the further shaft by means of the carriage unit during operation. The carriage unit in particular makes it possible to advantageously transfer the car from one shaft to another shaft.

It is advantageous that, in a shaft portion provided at the changeover point, the car can be moved by at least one friction drive unit which is arranged on a carriage unit provided at the changeover point. In this way, the drive principle can be advantageously transferred from the rest of the shaft to the carriage unit.

It is advantageous that, in the shaft portions of the shaft, the friction drive unit or the friction drive units of each shaft portion can be driven in an adjustable manner such that the car can be moved at a substantially continuously adjustable speed at least substantially in the entire shaft during operation. In this way, in particular a significant improvement in travel comfort for people can be achieved.

It is advantageous that in each shaft portion a plurality of friction drive units are used to drive the car, with the friction drive units being arranged in pairs on a shaft wall of the shaft or on a side of the car. This can, for example, allow improved force transmission to a traction plate arranged between two friction drive units in each case, with the two friction drive units preferably acting on the traction plate with opposing pressure forces.

It is advantageous that in each shaft portion a plurality of friction drive units are used to drive the car, with at least two friction drive units, in particular two pairs of friction drive units, being arranged on two opposite sides of the shaft or on two opposite sides of the car. This allows an improved drive of the car, which can thereby be balanced in particular with regard to a torque exerted on the car.

It is advantageous that the friction drive units forming a pair are arranged on a shaft wall substantially directly next to each other and in such a way that the running surfaces of these friction drive units are directed toward each other, so that during operation the car can be moved by engaging the traction plate between the two friction drive units. The two friction drive units can then preferably act on the traction plate with opposing pressure forces.

It is advantageous that the friction drive units reduce the speed of a car that is traveling to a stopping point at which another car is already stopping if it is determined that the traveling car will reach the stopping car at a non-reduced speed. An additional stop of the car can preferably be avoided, which improves traveling comfort.

It is advantageous that the friction drive units reduce the speed of a car traveling to a stopping point at which another car is already stopping if it is determined by a computing unit that the traveling car will, at a non-reduced speed, reach the stopping point of the stopping car within a stopping time at the stopping point determined by the computing unit for the stopping car, and that the stopping time for the stopping car at the stopping point is determined by the computing unit on the basis of passenger numbers. This provides an advantageous option for controlling the speed of the car. However, other options for reducing the speed are also conceivable, for example using a distance sensor. A controller can therefore also use the measured distance between two cars as an input variable and reduce the speed of one of these cars if necessary.

It is advantageous that cars are transferred from the at least one shaft to at least one second shaft at a changeover point, and that the speed of a car traveling from one of the shafts to a stopping point of another shaft at which another car is already stopping is already reduced by the friction drive units in the shaft before the changeover point to the other shaft if it is determined by a computing unit that the traveling car, at a non-reduced speed and taking into account a changeover time at the changeover point, will reach the stopping point of the stopping car within a stopping time at the stopping point determined by the computing unit for the stopping car. As a result, the traveling comfort is improved in particular in an improved manner.

It is advantageous that the drive device reduces the speed of a car, the speed of which is reduced with respect to at least one operating state of at least one of the other cars, to such an extent that the car is prevented from stopping before its next scheduled stop at a stopping point. Avoiding an additional stop of a car is a preferred specification for improving traveling comfort.

It is advantageous that the cars are moved at at least one standard speed and at least one reduced speed by the friction drive units. In particular, certain speeds can be specified for operation in order to simplify control and/or to specify preferred speeds.

It is advantageous that the elevator system comprises at least one changeover point which horizontally connects the two shafts, and at least one carriage unit, wherein the car can be displaced between the shafts by the carriage unit at the changeover point, that the car is moved relative to the carriage unit by at least one friction drive unit integrated in the carriage unit, which is designed in accordance with the friction drive units arranged in the shaft, i.e. for the vertical movement of the car, and in particular is moved into or out of the carriage unit and braked or accelerated, and held in place, and that when the car is changed from one shaft into another shaft, the carriage unit is displaced horizontally into the other shaft after the car has come to a standstill, and that the car is then moved vertically out of the carriage unit by the at least one friction drive unit integrated in the carriage unit and is then moved in the other shaft by the friction drive units arranged there. This provides a preferred embodiment that allows a car to be transferred from one shaft to another shaft. A considerable advantage is that the horizontal drive with which the carriage unit with the car possibly arranged therein can be adjusted is independent of a vertical drive for the car provided on the carriage unit. In particular, this means that it is not necessary for a drive to be rotated in space in order to achieve a horizontal movement of the car at one time and a vertical movement at another time. Since the friction drive unit is arranged in the carriage unit, in an advantageous embodiment the car can enter the carriage unit or, if necessary (if the carriage unit is not at one of the shaft ends and no horizontal displacement of the car is to take place), travel through the carriage unit, namely as if it were part of the shaft.

It is advantageous that a plurality of the carriage units described above and below can be provided in the shaft. There can be one carriage unit at the top and one at the bottom of the shaft. Carriage units which can displace the car into a sub-shaft, in particular into a waiting sub-shaft or exit sub-shaft, can be provided at additional floors. In one embodiment, two carriage units can be provided at the same shaft height, i.e. in the same shaft portion. In such an embodiment, a sub-shaft is provided on each side of the main shaft. One of the carriage units is always in the shaft, with the other carriage unit parked in one of the two sub-shafts. If a car has to be removed from the shaft, for example due to a defect, the carriage unit located in the shaft after the car has entered and braked can be moved into the free sub-shaft and parked there. The second carriage unit can then be moved from the other sub-shaft into the main shaft and used there as part of the drive for moving other cars.

Preferred embodiments of the invention shall be described in greater detail in the following description with reference to the accompanying drawings.

### DESCRIPTION OF THE DRAWINGS

FIG. 1 schematically shows a portion of an elevator system with a drive device according to one embodiment of the invention.

FIG. 2 schematically shows a portion of the elevator system of the embodiment, in which a portion of an elevator shaft of a building is shown in which two cars are currently arranged.

FIG. 3 schematically shows a portion of the elevator system of the embodiment from the viewing direction denoted by III in FIG. 2, and shows three elevator shafts of the building in which cars are arranged.

### DETAILED DESCRIPTION

An embodiment is described below with reference to the figures. A schematic representation is chosen here. In particular, further stopping points and floors may be provided between the stopping points or floors shown. Furthermore, a suitable number of cars can be guided through a suitable number of travel spaces or shafts in which the travel spaces are realized.

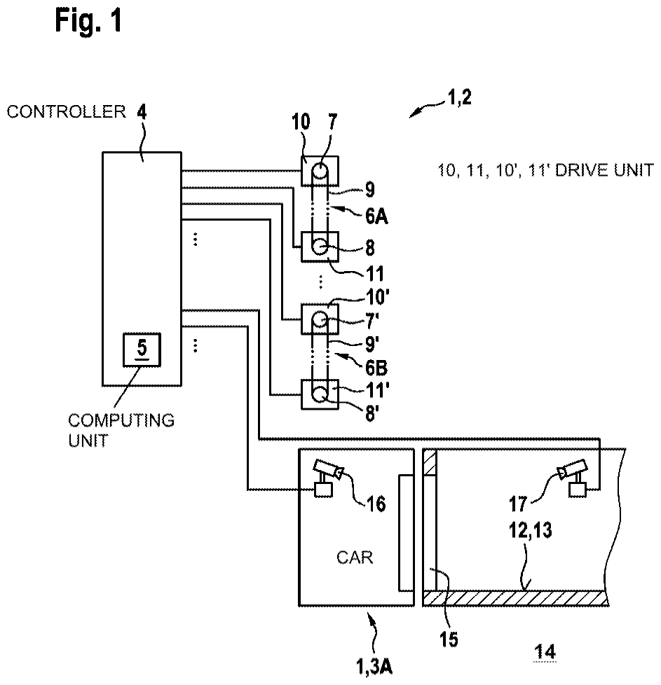

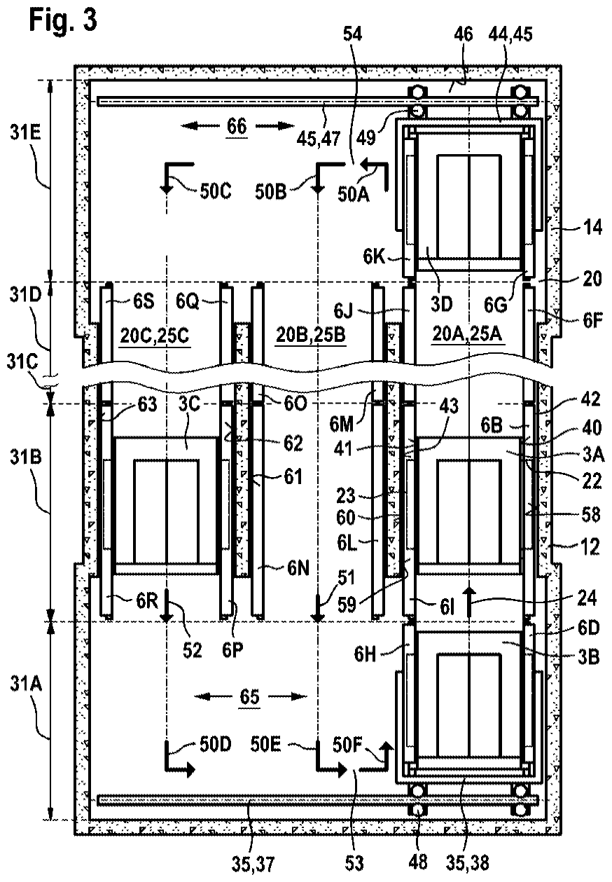

FIG. 1 schematically shows a portion of an elevator system 1 with a drive device 2 according to one embodiment of the invention. The elevator system 1 also has cars 3A to 3D (FIG. 3), of which the car 3A is shown as an example in FIG. 1. The drive device 2 has a controller 4. Furthermore, a computing unit 5 is provided, which can be part of the controller 4.

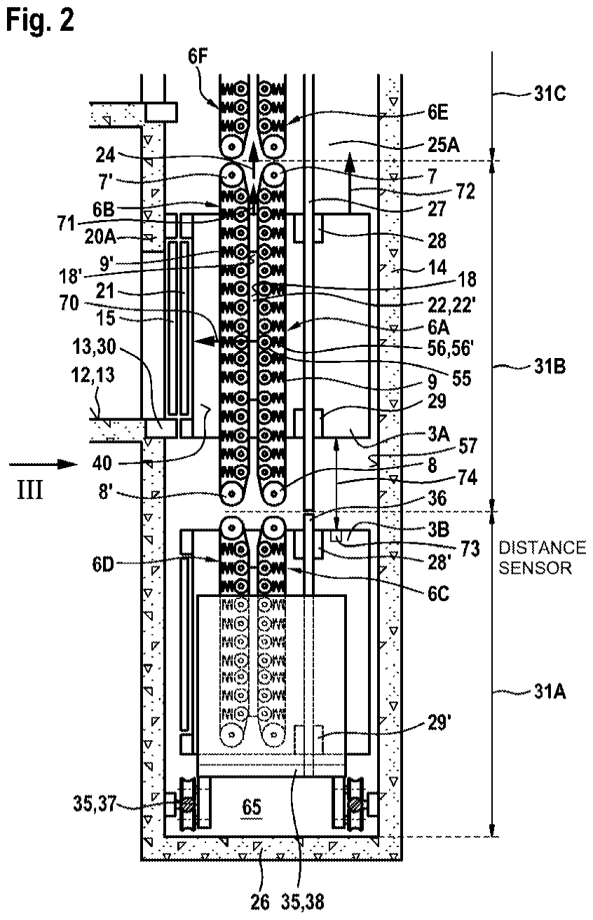

The drive device 2 has a plurality of friction drive units 6A to 6S (FIG. 2, FIG. 3), of which the friction drive units 6A, 6B are shown as an example in FIG. 1. The friction drive units 6A to 6S and other friction drive units not shown in the figures are preferably designed in a corresponding manner.

The friction drive unit 6A has friction wheels 7, 8 around which an endless belt 9 is guided. In this embodiment, both the friction wheel 7 and the friction wheel 8 are each driven by a drive unit 10, 11. The drive units 10, 11 can have electric motors and optionally gears, for example. In a corresponding manner, the friction drive unit 6B has friction wheels 7′, 8′ around which an endless belt 9′ is guided, with the friction wheels 7′, 8′ each being driven by a drive unit 10′, 11′. The drive units 10, 11, 10′, 11′ and other drive units are controlled by the controller 4.

The controller 4 controls the elevator system 1 on the basis of a variety of information. Such information relates to the calling of a car 3A to 3D to any stopping point, which is exemplified here by a stopping point 12 on a floor 13 of a building 14 to simplify the description. Furthermore, information can be provided that is used to determine a stopping time of the car 3A at the stopping point 12. This can relate in particular to the number of passengers who are in the car 3A or on the floor 13 at a floor door 15. For this purpose, for example, video information captured by a video camera 16 in the car 3A and a video camera 17 on the floor 13 can be evaluated by the computing unit 5. Thus, the computing unit 5 can determine the stopping time for the stopping car 3A at the stopping point 12 on the basis of passenger numbers, which is an approximation of an actual stopping time.

In addition or as an alternative, the controller 4 can also have the measurement of the distance between two cars 3A to 3D as an input variable.

FIG. 2 schematically shows a portion of the elevator system 1 of the embodiment, with a portion of a shaft 20A being shown. The shaft 20A can also be realized as part of a shaft arrangement 20 (FIG. 3) which is provided in the building 14. The cars 3A, 3B are currently in the section of the shaft 20A shown. The car 3A has a car door 21. Furthermore, traction plates 22, 23 (FIG. 3) are provided on the car 3A which, in the currently depicted position of the car 3A, interact with the endless belts 9, 9′ of the friction drive units 6A, 6B and with endless belts of further friction units 6J (FIG. 3). When the floor door 15 and the car door 21 are closed again after passengers have boarded and alighted, the controller 4 controls the drive units 10, 11, 10′, 11′ (FIG. 1) in such a way that the driven friction wheels 7, 8, 7′, 8′ move the endless belts 9, 9′ in a predetermined travel direction 24, which in this embodiment currently points upward. As a result, the car 3A is moved through a travel space 25A, which in this embodiment extends upward from a floor 26 in the travel direction 24 within the shaft 20A.

In addition, a car guide rail 27 on which the car 3A is guided via guide shoes 28, 29 is arranged so as to be stationary in the shaft 20A. The stopping point 12 can be determined by a floor door sill 30. The car 3B is designed in accordance with the car 3A. In particular, guide shoes 28′, 29′ are provided.

In the operating state shown, the car 3B is located on a transfer device 35, which is designed as a transverse displacement device 35 in this embodiment. The transfer device 35 has a car guide rail extension 36 which is arranged in a stationary manner on the transfer device 35. When the transfer device 35 has positioned the car 3B in the travel space 25A or the shaft 20A, the car guide rail extension 36 extends the car guide rail 27. When the car 3B is moved through the travel space 25A in the travel direction 24 by the friction drive units arranged on the transfer device 35 and then by the friction drive units 6A, 6B, the guide shoes 28′, 29′ are transferred from the car guide rail extension 36 to the car guide rail 27.

In this embodiment, the transfer device 35 is guided horizontally on at least one guide rail 37.

In a modified embodiment, the traction plates 22, 23 can also each be designed in multiple parts.

In a modified embodiment, the elevator system can also be designed without car guide rails. In this case, the car is guided exclusively by the friction wheel drives.

FIG. 3 schematically shows a portion of the elevator system 1 of the embodiment from the viewing direction denoted by III in FIG. 2, and shows three shafts 20A to 20C of the building 14 in which the cars 3A to 3D are arranged. The shaft 20A is divided into shaft portions 31A to 31E. In this embodiment, the shafts 20B, 20C are divided into the same shaft portions 31A to 31E in accordance with the shaft 20A. In a modified embodiment, however, the shafts can also be divided differently.

In this embodiment, the traction plates 22, 23 are arranged on a first side 40 and a second side 41 of the car 3A, with the sides 40, 41 facing away from each other. In the illustrated position of the car 3A, the traction plate 22 interacts with a pair of friction drive units 6A, 6B of the drive device 2 which are located on the first side 40 of the car 3A or on a first side 42 of the travel space 25A. Accordingly, in addition to the friction drive unit 6I, in this embodiment a further friction drive unit is provided which is concealed and thus not shown, so that, in the illustrated position of the car 3A, the traction plate 23 on the second side 41 of the car 3A or on a second side 43 of the travel space 25A interacts with a pair of friction drive units, in particular the friction drive unit 6I. A corresponding design also results from the transfer device 35 which is located at the bottom 26 of the building 14, and a transfer device 45 which is located in the region of a ceiling 46 of the shafts 20A to 20C of the shaft arrangement 20 or the building 14. Thus, in this embodiment, two pairs of friction drive units 6A to 6S always interact, and preferably all the friction wheels, in particular the friction wheels 7, 8, 7′, 8′, are driven. This reduces the load per drive unit 10, 11, 10′, 11′.

The transfer device 45 is designed in accordance with the transfer device 35. In this case, a guide rail 47 which is arranged in the region of the ceiling 46 and is horizontally aligned in this embodiment is provided for the transfer device 45. Drives 48, 49 make it possible to move the transfer devices 35, 45 horizontally, so that the individual cars 3A to 3D can be transferred between the individual travel spaces 25A to 25C. In order to transfer the cars 3A to 3D, particular transfer directions 50A to 50F can be specified, which can also vary in time if necessary. Accordingly, the travel directions 24, 51, 52 are specified for the travel of the cars 3A to 3D through the travel spaces 25A to 25C in this embodiment. A movement of the cars counter to the travel directions 24, 51, 52 is made possible by rotating the friction wheel drives. These may also vary in time. The travel directions 24, 51, 52 can be changed, for example, according to the number of passengers at peak times. In a modified embodiment, it is also conceivable that at least one further transfer device is implemented on any floor. In addition, it is conceivable that in at least one of the shafts 20A to 20C a specific number of floors is reserved for operation of a specific car with a constantly changing travel direction. This can be particularly useful in the case of a large number of shafts 20A to 20C and especially if at least one additional transfer device is provided on a suitable floor.

The drive device 2 can be designed in such a way that for example the speed of the car 3B traveling to the stopping point 12 at which the car 3A is already stopping is reduced if the computing unit 5 determines that the traveling car 3B will, at a non-reduced speed, reach the stopping point 12 of the stopping car 3A within a stopping time at the stopping point 12 determined by the computing unit 5 for the stopping car 3A.

The car 3B may have traveled through the travel space 25B in the travel direction 51 some time before the illustrated position, for example, with the next stopping point being the stopping point 12 or a further stopping point located behind the stopping point 12 according to the travel directions 24, 51, 52 and the transfer directions 50A to 50F.

The computing unit 5 can evaluate video information from the video camera 16, 17 in order to determine the stopping time for the stopping car 3A at the stopping point 12 on the basis of the number of passengers. In order to improve the traveling behavior for the passengers to be transported, it is advantageous if additional stopping and starting of the car 3B can be avoided. If the computing unit 5 determines that the car 3B has already reached the car 3A that is still stopping at the stopping point 12 within the determined stopping time, then additional stopping of the car 3B can be avoided, if necessary, by reducing the speed of the car 3B already in the shaft 20B. Accordingly, additional stopping in the shaft 20A can be avoided if necessary. This applies in particular if, in contrast with the schematic representation, there are further floors between the stop 12 or the floor 13 and the transfer device 35.

The drive device 2 is preferably designed in such a way that an at least substantially variable reduction in the speed of a car 3A to 3D is possible. The speed of the relevant car, for example the car 3B, can then be reduced in such a way that an additional stop before the next scheduled stop is avoided. For this purpose, all the friction drive units 6A to 6S are designed to be adjustable, so that the speed of each of the cars 3A to 3D can be adjusted individually and substantially continuously.

In a modified embodiment, it is also possible for only some of the friction drive units 6A to 6S to be designed to be adjustable, so that only they allow a continuous adjustment, in particular a continuous reduction, of the speed. This can result in particular in lower costs for the drive units 10, 11, 10′, 11′ and a lower control effort for the control unit 4. If necessary, one or more reduced speeds can also be implemented on at least some of the friction drive units 6A to 6S.

The drive device 2 of the elevator system 1 is thus designed in such a way that the speed of at least one of the cars 3A to 3D can be reduced with respect to at least one operating state of at least one of the other cars 3A to 3D. Such an operating state results in particular from the stopping of at least one car 3A to 3D at a stopping point, as is described using the example of the car 3A and stopping point 12.

In this embodiment, the friction drive units 6A to 6S each have additional wheels. Such a wheel 55 is identified as an example on the friction drive unit 6A shown in FIG. 2. The wheel 55 is pressed against the traction plate 22 by a preloaded spring 56. A force (pressing or tensioning force) 70 thus points to the traction plate 22. In this case, the force 70 points from a shaft wall 57 to the traction plate 22. In a modified embodiment, the traction plate 22 and the friction drive unit 6A can also be arranged in such a way that the force 70 points from one of the shaft walls 57 to 59 (FIGS. 2 and 3) to the car 3A. As a result, tensioning mechanisms 56′ can be implemented, of which the tensioning mechanism 56′, which among other things uses the spring 56, is identified as an example. The friction drive units 6A, 6B, 6E, 6F, 6I, 6J, 6L to 6S are arranged on shaft walls 58 to 63 of the shafts 20A to 20C. The friction drive units 6C, 6D, 6G, 6H, 6K and other friction drive units (not shown) are arranged on carriage units 38, 44 of the transfer devices 35, 45. During operation, it is then possible for example for a force (driving force) 71 to be transmitted from the friction drive units 6A, 6B, 6I and a further friction drive unit (not shown) to the car 3A. In this case, on the first side 40 of the car 3A, running surfaces 18, 18′ of the endless belts 9, 9′ interact with a part 22′ of the car 3A which is designed in this case as a traction plate 22. A corresponding drive of the car 3A is realized on its second side 41 on the part 23′ of the car 3A designed in this case as a traction plate 23.

The described design and mode of operation is therefore implemented on the other friction drive units, in particular the friction drive units 6C to 6H, 6J to 6S identified in the figures, in a corresponding manner when the car 3A travels through the shafts 20A to 20C, and is also implemented for the other cars 3B to 3D.

In this embodiment, the transfer devices 35, 45 have the carriage units 38, 44 on which the drives 48, 49 are arranged. As a result, the carriage units 38, 44 can be moved along the guide rails 37, 47 through horizontal travel spaces 65, 66. The horizontal travel space 65 results, for example, in a changeover point 53 corresponding to the transfer directions 50E, 50F between the shafts 20A, 20B. If, for example, the carriage unit 38 is arranged in the shaft portion 31A of the shaft 20A, then the car 3B can be moved out of the carriage unit 38 by the friction drive units 6C, 6D, 6H (mounted in the carriage unit 38; see FIG. 2) and the friction drive units 6A, 6B, 6I (mounted in the shaft), for example. Here, the advantage is that the same friction drive units 6C, 6D, 6H could previously be used to drive the car 3B into the carriage unit 38 for example from the shaft portion 31B of the shaft 20B, with the addition of the friction drive units 6K, 6L and 6N (mounted in the shaft), when the carriage unit 38 was located in the shaft portion 31A of the shaft 20B. The orientation and arrangement of the friction drive units 6C, 6D, 6H relative to the carriage unit 38 is fixed here, i.e. always unchanged.

Accordingly, for example, a changeover point 54 corresponding to the transfer directions 50A, 50B can be realized between the shafts 20A, 20B.

If, in a modified embodiment, a transfer device below and above which further shaft portions are located is provided in a shaft portion, then a suitably designed carriage unit can be provided that allows a car to be driven into the carriage unit both from below and from above. Friction drive units of the carriage unit then allow a car not only to change shaft at this changeover point, but also to travel through the changeover point in the same shaft.

The drive device 2 can also reduce the speed 72 of a car 3A to 3D on the basis of sensor data from a distance sensor 73 which measures a distance 74 from a car 3A traveling ahead, and a predetermined minimum distance. In this case, deceleration can take place if the distance falls below the predetermined minimum distance. Suitable sensors can also be used to draw conclusions about passenger numbers. The speed 72 can be detected via a suitable sensor, for example the speed 72 of the car 3A relative to the car guide rail 27 can be measured. The speed 72 can also be determined for example from a rotational speed of at least one of the friction wheels 7, 7′, 8, 8′.

The invention is not limited to the described embodiments.

In accordance with the provisions of the patent statutes, the present invention has been described in what is considered to represent its preferred embodiment. However, it should be noted that the invention can be practiced otherwise than as specifically illustrated and described without departing from its spirit or scope.

1-16. (canceled)

17. An elevator system comprising:
a shaft divided into multiple shaft portions;
a car arranged in the shaft;
a plurality of friction drive units mounted on at least one shaft wall of the shaft, each of the friction drive units having at least two friction wheels, and wherein the car is moved in the shaft portions by the friction drive units during operation of the elevator system; and
wherein at least one of the friction drive units in one of the shaft portions is adapted to be driven adjustably such that the car is moved at a continuously adjustable speed in the one shaft portion during the operation.

18. The elevator system according to claim 17 wherein the at least one friction drive unit in the one shaft portion includes an endless belt, the friction wheels of the at least one friction drive unit being surrounded by the endless belt and wherein at least one of the friction wheels is driven by a drive unit.

19. The elevator system according to claim 17 wherein the car includes at least one traction plate to which a driving force for moving the car in the shaft is temporarily transmitted by the at least one friction drive unit during the operation.

20. The elevator system according to claim 17 wherein the at least one friction drive unit includes additional wheels that are tensioned by a tensioning mechanism to exert a pressing force directed toward a part of the car.

21. The elevator system according to claim 20 wherein the tensioning mechanism includes at least one spring.

22. The elevator system according to claim 20 wherein the part of the car is a traction plate to which a driving force for moving the car in the shaft is temporarily transmitted by the at least one friction drive unit during the operation.

23. The elevator system according to claim 17 wherein the shaft is a first shaft and including a second shaft, a changeover point between the first shaft and the second shaft and a carriage unit displaceable at the changeover point between the first shaft and the second shaft during the operation, and wherein the car is transferred at the changeover point between the first shaft and the second shaft by the carriage unit during the operation.

24. The elevator system according to claim 23 wherein at ones of the shaft portions connected at the changeover point, the car is moved by a friction drive unit arranged on the carriage unit between the first shaft and the second shaft.

25. The elevator system according to claim 17 wherein at least one of:
at least one of the friction drive units in each of the shaft portions is adapted to be driven adjustably such that the car is moved at a continuously adjustable speed in the shaft during operation;
the friction drive units are arranged in pairs on one of the shaft wall of the shaft or on a side of the car in each of the shaft portions; and
the friction drive units are arranged in two pairs friction drive units on two opposite ones of the shaft walls of the shaft or on two opposite sides of the car in each of the shaft portions.

26. The elevator system according to claim 25 wherein the friction drive units forming each of the pairs are arranged on the shaft wall directly next to each other such that running surfaces of the friction drive units in each of the pairs are directed toward each other, and wherein the car is moved by engaging a traction plate on the car between the running surfaces.

27. A method for driving the car of the elevator system according to claim 17 including operating the friction drive units to continuously adjust a speed of the car based on at least one operating state of another car in the elevator system.

28. The method according to claim 27 including operating the friction drive units to reduce the speed of the car when traveling to a stopping point at which the another car is stopped or stopping when it is determined that the car traveling will reach the another car at the stopping point at a non-reduced speed.

29. The method according to claim 27 including operating the friction drive units to reduce the speed of the car when traveling to a stopping point at which the another car is stopped or stopping when it is determined by a computing unit that the car traveling will, at a non-reduced speed, reach the stopping point within a stopping time at the stopping point determined by the computing unit for the another car, and determining the stopping time by the computing unit based on passenger numbers.

30. The method according to claim 27 including transferring the car from the shaft to another shaft of the elevator system at a changeover point, and operating the friction drive units to reduce the speed of the car traveling from the shaft to a stopping point of the another shaft at which the another car is stopping or stopped before the car reaches the changeover point when it is determined by a computing unit that the car, traveling at a non-reduced speed and taking into account a changeover time at the changeover point, will reach the stopping point within a stopping time at the stopping point for the another car determined by the computing unit.

31. The method according to claim 27 including operating the friction drive units to reduce the speed of the car wherein the car is prevented from stopping before reaching a next scheduled stop at a stopping point.

32. The method according to claim 27 wherein the friction drive units are adapted to move the car at a standard speed and at least one reduced speed.

33. The method according to claim 27 wherein the shaft is a first shaft and the elevator system includes a second shaft, the car and the another car being moved in the first and second shafts by the friction drive units arranged on shaft walls of the first and second shafts, and operating the friction drive units to move the car and the another car through the first and second shafts at continuously adjustable speeds during the operation of the elevator system.

34. The method according to claim 33 wherein the elevator system includes a changeover point that horizontally connects the first and second shafts, and at least one carriage unit, wherein each of the car and the another car is displaceable between the first and second shafts by the carriage unit at the changeover point, wherein the car and the another car are moved relative to the carriage unit by at least another friction drive unit integrated in the carriage unit, the another friction drive unit braking, accelerating and holding in place the car and the another car, and when one of the car and the another car in one of the first and second shafts comes to a standstill at the carriage, displacing the carriage unit horizontally into another of the first and second shaft and then moving the one car vertically out of the carriage unit by the another friction drive unit into the another shaft.
